(19) United States
(12) Patent Application Publication
(10) Pub. No.: US 2010/0235834 A1
(43) Pub. Date: Sep. 16, 2010

(54) PROVIDING A MANAGEMENT COMMUNICATION CHANNEL BETWEEN A SOFTWARE LAYER AND PLATFORM LAYER FOR HARDWARE MANAGEMENT CONTROL

(76) Inventors: Scott P. Faasse, Tomball, TX (US); Nicholas S. Judge, Bellevue, WA (US); Stephen R. Berard, Seattle, WA (US); Tristan A. Brown, Redmond, WA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/404,387

(22) Filed: Mar. 16, 2009

(51) Int. Cl. G06F 9/455; G06F 1/12

(52) U.S. Cl. 718/1; 713/600

(57) ABSTRACT

A system includes hardware, a software layer, a platform layer, and a management communication channel between the software layer and the platform layer. The management communication channel provides an interface to enable the software layer to issue a hardware management command to the platform layer, where the hardware management command is to specify a change of a setting of the hardware, and where the management communication channel allows a hardware management engine of the platform layer to collaborate with the software layer to perform the change of the setting of the hardware.

### BACKGROUND

In a computer system, power management control is performed to manage the amount of power consumption in the computer system. For example, when there is relatively low activity in the computer system, settings can be changed to reduce power consumption, such as by reducing the clock frequency of a processor or other electronic device, or by reducing a power supply voltage provided to the processor or other electronic device.

Existing techniques of power management control, such as techniques based on the Advanced Configuration and Power Interface (ACPI) standard, are usually platform-dependent. The specific power management control may differ for different platforms (e.g., different platforms using different types of processors). Also, existing techniques of power management control may not allow power management features provided by different system components (e.g., operating system and platform firmware) to co-exist in a system.

### BRIEF DESCRIPTION OF THE DRAWINGS

Some embodiments of the invention are described with respect to the following figures:

FIG. 1 is a block diagram of an exemplary system in which an embodiment of the invention is incorporated;

FIG. 2 illustrates content of a shared memory region that provides a management communication channel between a software layer and platform firmware, according to an embodiment;

FIG. 3 is a flow diagram of a process of performing power management control according to an embodiment; and

FIG. 4 is a block diagram of another exemplary system in which an embodiment of the invention is incorporated.

### DETAILED DESCRIPTION

In accordance with some embodiments, to perform hardware management control (such as power management or thermal management control), a management communication channel is provided between a software layer and platform firmware within a system. The management communication channel provides an abstract interface between the software layer and platform firmware to enable the software layer to issue hardware management commands to the platform firmware to cause a change in a hardware management setting of system hardware. The abstract interface also allows the software layer to obtain, from the platform firmware, information regarding hardware components. The information can include feedback information regarding the level of performance delivered. The information can also include indications that the performance requested by a request from a software layer cannot be satisfied.

The abstract interface provided by the management communication channel allows commands and other information exchanged between the software layer and the platform firmware to have abstract formats that are the same (or common) for different types of the hardware in the system. In addition, the management communication channel allows collaboration between the software layer and the platform firmware in providing hardware management control in the system.

Performing hardware management control involves performing control of settings and/or tasks performed by hardware components of a system. One type of hardware management control is power management control, where power consumption of one or more hardware components can be varied, such as by changing the clock frequency of input clock(s) to the hardware component(s), or by changing the power supply voltage(s) provided to the hardware component(s). In the ensuing discussion, reference is made to power management control using mechanisms according to some embodiments. Note that the same or similar mechanisms can be applied to other types of hardware management control.

The software layer noted above can be an operating system (OS) of a computer system, for example. The OS can also include a power management driver to perform power management control in the computer system.

Alternatively, the software layer can be a virtual machine monitor (VMM) (also referred as a “hypervisor”), which virtualizes hardware resources of a computer system. The VMM allows for virtual machines to be deployed in the computer system, where a virtual machine refers to an arrangement of components for virtualizing or emulating a physical machine. A virtual machine can include an operating system, software applications, and virtual hardware. The VMM intercepts requests for resources from operating systems in respective virtual machines, and provides access of the hardware resources to the virtual machines. The VMM can also include a module to perform power management control.

More generally, the software layer can be any software power management module in a computer system.

The platform firmware refers to programmable content embedded in hardware components, such as microprocessors, application-specific integrated circuits (ASICs), programmable logic devices, peripheral devices, and so forth. Platform firmware can include basic input/output system (BIOS) code that is loaded and executed for performing initialization and other boot tasks for initializing and booting the computer system. Platform firmware can also include other code, such as code to perform management of the health of the computer system, and so forth. The BIOS code can include a power management engine to perform power management tasks in the computer system. Mechanisms according to some embodiments can also be applied to an implementation that uses the Unified Extensible Firmware Interface (UEFI), which is an interface between an operating system and platform firmware. Also, the platform firmware can in some implementations include baseboard management controller (BMC) firmware.

Conventionally, a computer system customer typically has to choose between platform firmware-based control or OS-based control, to perform power management tasks such as controlling the clock frequency of hardware components (e.g. processors). Conventional techniques do not provide for easy deployment of both the platform firmware-based power management control features and the OS-based power management control features in the same system.

Moreover, existing interfaces, such as interfaces provided by the Advanced Configuration and Power Interface (ACPI) Specification do not provide for adequate abstraction for power management control in the system. Different systems may use different types of processors or other hardware. Power management software that employ ACPI methods for power management control typically has to consult information, such as information stored in tables, to determine how power management control is to be performed for different types of hardware. The power management software, such as the power management driver of the OS, may be made more complicated by having to support different types of hardware.

In accordance with some embodiments, the abstract interface provided by the management communication channel between the software layer and platform firmware allows for platform-independent power management control and also allows for effective collaboration between the software layer and the platform firmware. In some embodiments, the platform firmware remains in control of hardware components. The software layer can compute the target performance of a hardware component (such as a processor) and can request such target performance in a command sent to the platform firmware over the management communication channel. The platform firmware is responsible for managing the hardware controls to deliver the requested performance. The management communication channel also allows the software layer to obtain information regarding the actual performance level delivered, or to receive indications from the platform firmware that the requested performance level could not be obtained.

Note that the term “platform firmware” is intended to cover virtual platform firmware as well, such as firmware emulated by a virtual machine.

In some embodiments, the management communication channel is a shared memory region, which is a region of system memory allocated to store information to allow for the software layer and the platform firmware to exchange power management command and status information for the purpose of power management control. Alternatively, instead of being in system memory, the shared memory region can be memory located in other components of a system, such as memory in I/O (input/output) devices that are mapped into memory space.

Although this discussion refers to providing the management communication channel between a software layer and platform firmware, note that the management communication channel can more generally be provided between a software layer and a platform layer, where “platform layer” can refer to firmware and/or hardware.

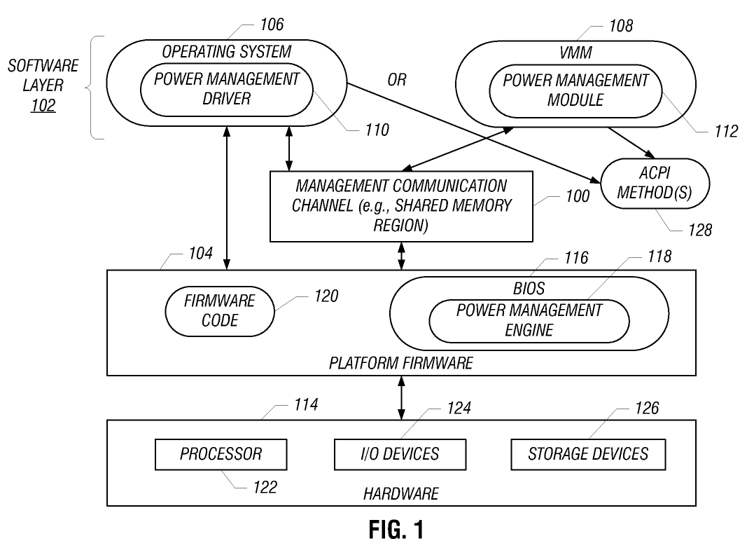

FIG. 1 shows an exemplary computer system that includes a management communication channel 100 according to some embodiments between a software layer 102 and platform firmware 104. The computer system can be a personal computer, notebook computer, server computer, communications switch, router, storage system, and so forth. As shown in FIG. 1, the software layer 102 can include an OS 106, or alternatively, a VMM 108. Note that in some embodiments, both the OS 106 and VMM 108 can co-exist in the computer system, with one or both of the OS 106 and VMM 108 configured to use the communication channel 100. The OS 106 has a power management driver 110 to perform power management tasks with respect to hardware 114 in the computer system of FIG. 1. Similarly, the VMM 108 includes a power management module 112 to perform power management control with respect to the hardware 114.

The platform firmware 104 includes BIOS code 116. The BIOS code 116 includes a power management engine 118 that is able to perform power management tasks with respect to the hardware 114. The platform firmware 104 also includes other firmware code 120 to perform other tasks, such as system health-related tasks, and so forth.

The hardware 114 of the computer system includes various components, including one or more processors 122, input/output (I/O) devices 124 (e.g., video subsystem, network interface controller, etc.), and storage devices 126. The storage devices 126 can include persistent storage devices such as disk-based storage devices (magnetic or optical disk-based storage devices) and volatile memory devices such as random access memory devices (e.g., dynamic random access memories, static random access memories, and so forth).

In some embodiments, the management communication channel 100 that provides the abstract interface between the software layer 102 and the platform firmware 104 for the purposes of exchanging power management information (commands and status) can be a shared memory region that is an allocated region within a memory device of the storage devices 126. In other embodiments, other types of management communication channels can be employed.

Also shown in FIG. 1 are one or more methods (software routines) 128. In one embodiment, the method(s) 128 can be ACPI method(s). The ACPI method(s) can be called by the software layer 102 to discover presence of the management communication channel 100 (which is provided by the platform firmware 104) and to discover characteristics (content and locations of such content) of the management communication channel 100. In other embodiments, other control mechanisms besides the ACPI method(s) 128 can be employed to allow the software layer and/or platform firmware 104 to discover the management communication channel 100.

The power management control that can be performed in the computer system using the management communication channel 100 can include control of clock frequency of hardware devices, such as the processor(s) 122. Increasing the clock frequency of the processor 122 increases power consumption by the processor 122 and its performance, while decreasing the clock frequency of a processor reduces its power consumption and its performance. More generally, the power management control is to change a performance characteristic of the processor(s) 122, which is based on one or both of the processor clock frequency or voltage level. In other embodiments, other types of power management control can be performed using the management communication channel 100, such as changing power voltage levels supplied to hardware devices, and other tasks. As yet another alternative, the clock frequency of the processor 122 can be varied for thermal management purposes (e.g. the clock frequency is reduced in response to an elevated temperature in the computer system).

In addition to allowing the software layer 102 to issue commands to the platform firmware 104 to perform power management control, the management communication channel 100 also allows for the software layer 102 to obtain information regarding the hardware 114, such as to obtain a status or setting relating to power management of the hardware 114. In one specific example, a setting of the hardware 114 that can be retrieved by the software layer 102 through the management communication channel 100 is the clock frequency of the processor 122. Other settings can be obtained in other embodiments, including clock frequencies of other hardware devices, power voltage levels of hardware devices, and so forth.

In some implementations, an alert mechanism can be provided by the management communication channel 100 for providing alerts between the software layer 102 and the platform firmware 104. For example, the software layer 102 can send an alert that a command has been sent through the management communication channel 100, or the platform firmware 104 can send an alert that a command has been executed. The alert can be provided by using an interrupt or some other type of event.

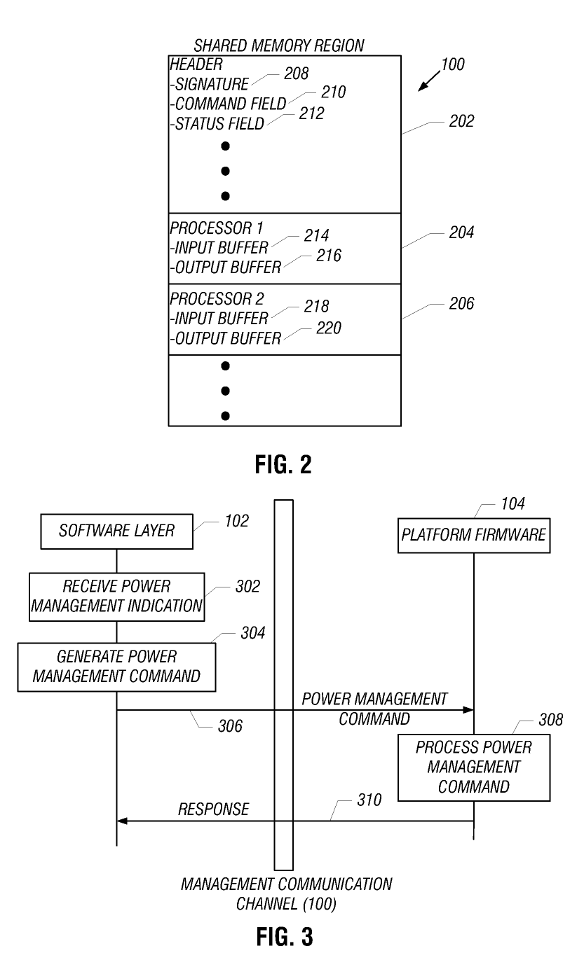

FIG. 2 shows an example shared memory region 100 that is accessible by the software layer 102 and the platform firmware 104. Although a specific example is depicted in FIG. 2, note that other arrangements of the shared memory region 100 can be provided in other implementations.

In the example of FIG. 2, the shared memory region 100 includes a header 202, where the header 202 has various elements, including a signature 208 that indicates that the memory region associated with the signature 208 is used as a shared memory region to provide the management communication channel 100 between the software layer 102 and platform firmware 104 for power management control.

Another element in the header 202 is a command field 210 in which one of multiple power management commands can be inserted by the software layer 102 to perform a corresponding action. Examples of commands that can be provided in the command field 210 include a command to obtain a processor clock frequency, such as an average clock frequency of the processor. This command is a query to obtain the running frequency of the processor since the last time the command was last completed. The return value of the command to obtain the average frequency is a ratio of the running frequency to a nominal processor frequency (where the nominal processor frequency is a predefined nominal frequency of the processor). In other implementations, other manners of recording the frequency of the processor can be provided.

Another command is a command to set a target clock frequency of a processor. In some implementations, the target clock frequency can be in the form of a ratio (ratio of the target clock frequency to the nominal frequency of the processor).

Another element of the header 202 is a status field 212, which provides an indication of a status of a previously issued command.

The shared memory region 100 also includes additional sub-regions for respective hardware components. For example, in a computer system having multiple processors 122, corresponding sub-regions (e.g., 204 and 206 shown in FIG. 2) are provided in the shared memory region 100. The sub-region 204 corresponds to a first processor, while the sub-region 206 corresponds to a second processor.

The sub-region 204 includes an input buffer 214 and an output buffer 216. The input buffer 214 can be populated with information that corresponds to the command entered in the command field 210 of the header 202. For example, if the command is to set a target processor frequency of the first processor, then the input buffer 214 can be populated with the target processor frequency. Other control information can also be provided in the input buffer 214.

The sub-region 204 also includes an output buffer 216, which contains information populated by the platform firmware 104. For example, if the software layer 102 submitted a command to retrieve the clock frequency of the first processor, then the output buffer 216 is filled with the clock frequency value. Other information can also be provided in the output buffer 216.

The sub-region 206 for the second processor similarly includes an input buffer 218 and output buffer 220.

FIG. 3 is a flow diagram of a process according to an embodiment that is performed by the software layer 102 (either by the power management driver 110 of the operating system 106 or by the power management module 112 of the VMM 108, for example). The software layer 102 receives (at 302) an indication that power management control is to be affected.

In response to the received indication, the software layer 102 generates (at 304) a power management command. The power management command can be a command to change a power management setting of the hardware 114 (FIG. 1) of the computer system. Alternatively, the power management command can be a command to retrieve a power management setting of the hardware 114.

The command is then issued (at 306) to the management communication channel 100 (FIG. 1). For example, the generated command can be used to populate the command field 210 in the shared memory region 100 (FIG. 2). Also, if appropriate, the input buffer 214 or 218 of the shared memory region 100 is also populated. For example, if the command is to change the clock frequency of a processor, then the input buffer 214 or 218 is populated with a value indicating the target clock frequency for the processor.

The power management command issued to the management communication channel 100 is received by the platform firmware 104, which processes (at 308) the command and effects action in response to the command, which can involve accessing the hardware 114.

The platform firmware 104 sends (at 308) a response through the management communication channel 100 to the software layer 102. The software layer 102 can monitor the status field 212 and/or output buffer 216 or 220 of the shared memory region 100 of FIG. 2, for example. The status field 212 can be populated with values indicating whether or not the command has successfully completed, or whether an error has occurred. In addition, if the command issued (at 306) by the software layer 102 is a command to obtain information of a hardware component, then the output buffer 216 or 220 of the shared memory region 100 can be populated with a value (e.g., processor clock frequency ratio) of the hardware 114 that is being sought by the software layer 102.

In the manner described above, the power management module (power management driver 110 or power management module 112) of the software layer 102 can collaborate with the power management engine 118 of the platform firmware 104 (FIG. 1) to perform power management tasks. In such an arrangement, the power management engine 118 of the platform firmware 104 remains in direct control of the hardware's power management performance. The power management module in the software layer 102, however, computes the desired performance level of the hardware and sends a request (through the management communication channel 100) to the power management engine 118 of the platform firmware 104 to effect the desired performance level (e.g., desired processor clock frequency ratio). The power management engine 118 of the platform firmware 104 is responsible for managing the hardware settings (e.g. hardware clocking controls) to deliver the requested performance level. Also, the platform firmware 104 can set indicators (such as flags) to indicate that the platform firmware 104 was unable to deliver the requested performance.

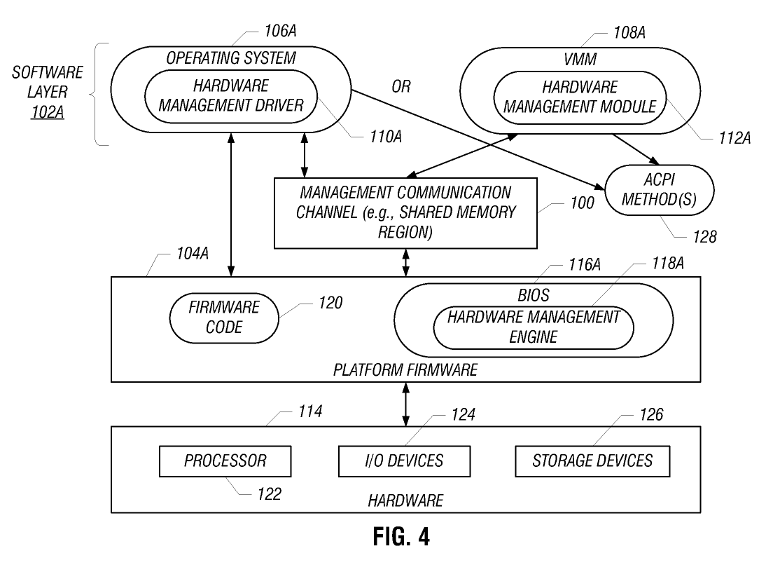

The above has described an embodiment in which the software layer 102 performs power management control with respect to hardware 114. In a different embodiment, as shown in FIG. 4, other types of hardware management control can be performed with respect to the hardware 114. More generally, in this alternative embodiment, a software layer 102A includes either an OS 106A having a hardware management driver 110A or a VMM 108A having a hardware management module 112A. The hardware management driver 110A and hardware management module 112A performs hardware management tasks with respect to one or more hardware components. For example, the hardware management tasks can include changing a state of a hardware component, changing a setting in a hardware component, and so forth.

This computer system of FIG. 4 also includes platform firmware 104A having BIOS code 116A with a hardware management engine 118A.

The software layer 102A is able to issue hardware management commands through the management communication channel 100 to the platform firmware 104A to either adjust a setting of the hardware 114 or to obtain information of the hardware 114.

Instructions of software and/or firmware described above (including software layer 102 or 102A and platform firmware 104 or 104A of FIG. 1 or 4) are loaded for execution on a processor (such as processor(s) 122). The processor includes microprocessors, microcontrollers, processor modules or subsystems (including one or more microprocessors or microcontrollers), or other control or computing devices.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A system comprising:
hardware;
a software layer;
a platform layer; and
a management communication channel between the software layer and the platform layer, wherein the management communication channel provides an interface to enable:
the software layer to issue a hardware management command to the platform layer, wherein the hardware management command is to specify a change of a setting of the hardware, and wherein the management communication channel allows a hardware management engine of the platform layer to collaborate with the software layer to perform the change of the setting of the hardware; and
the platform layer to provide information relating to the hardware to the software layer.

2. The system of claim 1, wherein the interface of the management communication channel is an abstract interface to allow the hardware management command to be an abstract command that is common for different types of the hardware.

3. The system of claim 1, wherein the software layer comprises at least one component of an operating system, and wherein the hardware management command is to change one of a power management setting or thermal management setting of the hardware.

4. The system of claim 1, wherein the software layer comprises at least one component of a virtual machine monitor, and wherein the hardware management command is to change one of a power management setting and a thermal management setting of the hardware

5. The system of claim 1, wherein the management communication channel comprises a shared memory region accessible by the software layer and the platform layer.

6. The system of claim 1, wherein the hardware includes a processor, and wherein the hardware management command is a command to cause a change in a clock frequency of the processor.

7. The system of claim 1, wherein the hardware includes a processor, and wherein the hardware management command is a command to request a change in a performance characteristic of the processor, wherein the performance characteristic is defined by one or both of a clock frequency of the processor and a voltage level of the processor.

8. The system of claim 1, wherein the hardware includes plural processors, wherein the management communication channel includes different data structures for corresponding ones of the plural processors, and wherein the hardware management command is communicated through a particular one of the different data structures of the management communication channel to the platform layer depending upon which of the plural processors is targeted.

9. The system of claim 1, further comprises:
a control mechanism to enable the operating system to discover the management communication channel.

10. The system of claim 9, wherein the control mechanism comprises at least one Advanced Configuration and Power Interface object.

11. The system of claim 1, wherein the management communication channel enables the software layer to further issue another hardware management command to the platform layer to request a status or setting of the hardware.

12. An article comprising at least one computer-readable storage medium containing instructions that when executed cause a computer system to provide an interface comprising:
a management communication channel between a software layer and platform firmware; and
one or more software routines to enable the software layer to discover the management communication channel,
wherein the management communication channel enables the software layer to send a power management command to the platform firmware to perform power management with respect to hardware in the computer system; and
wherein the management communication channel enables the software layer to receive information pertaining to the hardware from the platform firmware.

13. The article of claim 12, wherein the management communication channel comprises a shared memory region accessible by the software layer and the platform firmware, wherein the shared memory region comprises a command field in which the power management command is written to communicate the command field to the platform firmware, and wherein the shared memory region further comprises another data structure to allow the platform firmware to provide feedback information to the software layer.

14. The article of claim 12, wherein management communication channel enables a power management module of the software layer to collaborate with a power management engine of the platform firmware to perform the power management.

15. The article of claim 14, wherein the power management engine is to adjust a hardware control of the hardware in response to the hardware management command.

16. A method of performing power management control, comprising:
providing an abstract interface between a power management module of a software layer and a power management engine of a platform firmware;
sending, from the software layer power management module to the platform firmware power management engine, a power management command through the abstract interface; and
in response to the power management command, the platform firmware adjusting a hardware control of a hardware component.

17. The method of claim 16, wherein the abstract interface allows the power management command to have a common format irrespective of a type of the hardware component.

18. The method of claim 16, wherein sending the power management command comprises sending the power management command to set a target clock frequency of the hardware component.

19. The method of claim 16, wherein further comprising sending another power management command to obtain a setting of the hardware component.
